(19) United States
(12) Patent Application Publication
(10) Pub. No.: US 2024/0410059 A1
(43) Pub. Date: Dec. 12, 2024

(54) WATER ELECTROLYSIS METHOD

(71) Applicant: TOYOTA JIDOSHA KABUSHIKI KAISHA, Aichi-ken (JP)

(72) Inventor: Haruyuki NAKANISHI, Nagoya-shi (JP)

(21) Appl. No.: 18/735,184

(22) Filed: Jun. 6, 2024

(30) Foreign Application Priority Data
Jun. 9, 2023 (JP) 2023-095891

(51) Int. Cl. C25B 1/04; C25B 9/17; C25B 9/70; C25B 11/091; H01M 10/30

(52) U.S. Cl. CPC C25B 1/04; C25B 9/17; C25B 11/091; C25B 9/70; H01M 10/30

(57) ABSTRACT

A water electrolysis method according to the present disclosure includes, by using a power source, an electrolytic solution that is capable of transferring OH-ions, and a single nickel-hydrogen battery that has a positive electrode connected to the power source, and a negative electrode connected to the power source, and that is immersed in the electrolytic solution, applying, by the power source, a potential difference in which a potential of the positive electrode is higher than a potential of the negative electrode, to generate oxygen gas from the positive electrode and hydrogen gas from the negative electrode.

### CROSS-REFERENCE TO RELATED APPLICATION

This application is based on and claims priority under 35 USC 119 from Japanese Patent Application No. 2023-095891 filed on Jun. 9, 2023, the disclosure of which is incorporated by reference herein.

### BACKGROUND

### Technical Field

The present disclosure relates to a water electrolysis method using a single nickel-hydrogen battery.

### Related Art

In recent years, there has been an increasing demand for hydrogen (H₂) gas as energy for fuel-cell vehicles and power generation, and studies have been conducted on methods for producing H₂ gas. It should be noted that examples of the methods for producing H₂ gas include, for example, a method in which water (H₂O) is separated into hydrogen (H₂) gas and oxygen (O₂) gas by a water electrolysis reaction and recovery is performed.

For example, Japanese National Phase Publication (JP-A) No. 2017-534764 discloses technology of a water electrolysis cell using platinum (Pt) for a negative electrode and nickel hydroxide (Ni(OH)₂) for a positive electrode, in which oxygen is occluded and released at the positive electrode, and oxygen is not released when hydrogen is generated at the negative electrode.

However, in Japanese National Phase Publication (JP-A) No. 2017-534764, platinum (Pt) having a wide potential window is used for the negative electrode. In other words, upper and lower limit potentials of the negative electrode during the electrochemical reaction can be greatly varied (the upper and lower limit potentials need not be considered). As a result, a potential of the counter positive electrode can vary greatly. Although the nickel hydroxide (Ni(OH)₂) used for the positive electrode continues to reversibly react if the valence variation of Ni is between divalent and trivalent, when the potential variation is increased to a valence variation of between, for example, divalent and tetravalent, the positive electrode may irreversibly deteriorate (an oxide coating film is formed on the positive electrode), and the efficiency of gas generation by water electrolysis may decrease.

In this regard, nickel-hydrogen batteries have already been widely used as batteries installed in electric vehicles and hybrid vehicles, but in the future, the amount of spent nickel-hydrogen batteries that is generated is expected to increase. For this reason, it is desirable for a spent nickel-hydrogen battery to be able to be used as a water electrolysis cell in a form that is as close to reuse as possible. However, in a nickel-hydrogen battery, the negative electrode is Ni-based, and the positive electrode is Ni(OH)₂ based. Since a potential window of Ni of the negative electrode is narrower than that of the negative electrode of Japanese National Phase Publication (JP-A) No. 2017-534764, it is necessary to use the nickel-hydrogen battery in a manner in which upper and lower limit potentials are limited at the time of water electrolysis. In Japanese National Phase Publication (JP-A) No. 2017-534764, since Pt, which has a wide potential window, is used for the negative electrode, attention has not been paid to how to apply potentials in consideration of deterioration of both the positive electrode and the negative electrode.

### SUMMARY

In view of such existing demands, it is an object of the present disclosure to provide a water electrolysis method that uses a single nickel-hydrogen battery and that has high energy conversion efficiency.

Means for solving the above-described problem include the following means.
<1> A water electrolysis method including:
   by using:
      a power source,
      an electrolytic solution that is capable of transferring OH-ions, and
      a single nickel-hydrogen battery that has a positive electrode connected to the power source, and a negative electrode connected to the power source, and that is immersed in the electrolytic solution,
   applying, by the power source, a potential difference in which a potential of the positive electrode is higher than a potential of the negative electrode, to generate oxygen gas from the positive electrode and hydrogen gas from the negative electrode.
<2> The method according to <1>, wherein the negative electrode includes a mischmetal.
<3> The method according to <1> or <2>, wherein:
   the negative electrode has a film containing Ni₂O₃H; and
   a voltage is applied so that the positive electrode and the negative electrode have a predetermined first potential difference to generate only hydrogen gas, or a voltage is applied so that the positive electrode and the negative electrode have a predetermined second potential difference to generate only oxygen gas.

According to the present disclosure, it is possible to provide a water electrolysis method that uses at least one nickel-hydrogen battery and that has high energy conversion efficiency.

### BRIEF DESCRIPTION OF THE DRAWINGS

Exemplary embodiments of the present disclosure will be described in detail based on the following figures, wherein:

FIG. 1 is a schematic perspective view of a device that implements a water electrolysis method in an exemplary embodiment of the present disclosure;

FIG. 2 is a schematic perspective view of a device that implements a water electrolysis method in another exemplary embodiment of the present disclosure;

FIG. 3 is a schematic diagram illustrating a configuration in which a plurality of positive electrodes and a plurality of negative electrodes included in a single battery module are connected to a power source in the water electrolysis device shown in FIG. 2;

FIG. 4 is a potential-pH diagram for Ni at 80° C.;

FIG. 5 is a potential-pH diagram for Ni at 50° C.; and

FIG. 6 is a schematic diagram illustrating an example of a configuration of a nickel-hydrogen battery.

### DETAILED DESCRIPTION

Below, a water electrolysis method of the present disclosure will be explained in detail with reference to the drawings. The respective drawings shown below are schematically illustrated, and sizes and shapes of the respective parts have been appropriately exaggerated for ease of understanding.

In the present disclosure, a “single nickel-hydrogen battery” may be a single battery cell, or may be a single battery module having plural battery cells. A “single battery cell” refers to a battery of a minimum structural unit in which the single body thereof functions singularly and independently as a battery. A “single battery module” refers to a battery in which plural cells are combined to function singularly and independently as a battery.

### Water Electrolysis Method

In the water electrolysis method according to the present disclosure, a power source, an electrolytic solution, and a single nickel-hydrogen battery are used. The nickel-hydrogen battery has a positive electrode connected to the power source and a negative electrode connected to the power source, and is immersed in the electrolytic solution. Then, by applying, by the power source, a potential difference (voltage) in which a potential of the positive electrode is higher than a potential of the negative electrode, hydrogen gas (H₂) is generated from the negative electrode, and oxygen (O₂) gas is generated from the positive electrode.

### Battery Cell

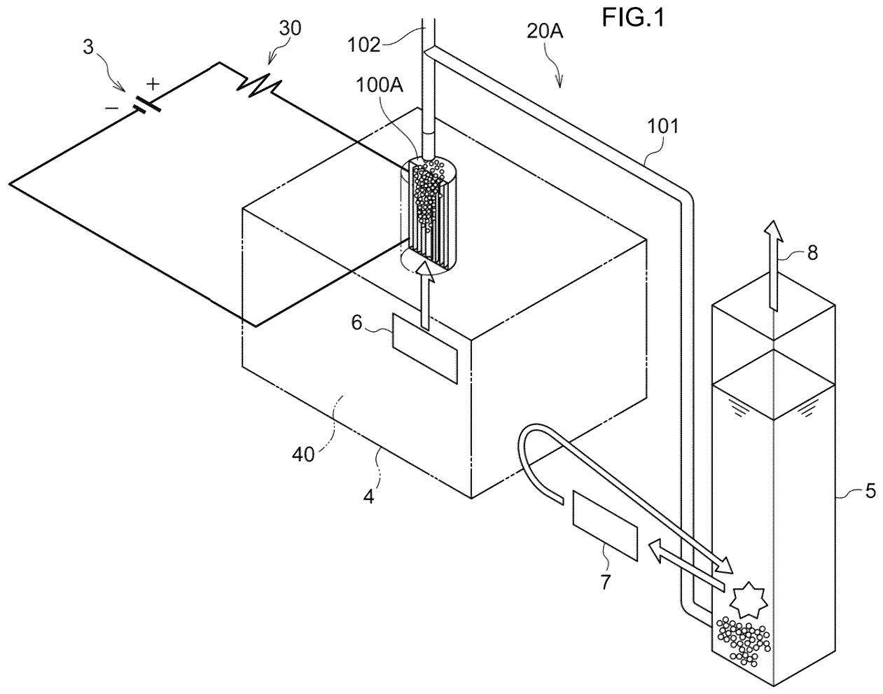

An exemplary embodiment of the water electrolysis method according to the present disclosure will be explained with reference to the device illustrated in FIG. 1, in which a “battery cell” is used as the single nickel-hydrogen battery.

FIG. 1 is a schematic perspective view illustrating a water electrolysis device that implements the water electrolysis method of the present disclosure. As shown in FIG. 1, a water electrolysis device 20A includes a power source 3, a resistor 30, which is an example of an electronic load, a housing 4 in which an electrolytic solution 40 is accommodated, a battery cell 100A that is immersed in the electrolytic solution 40 within the housing 4, and a distillation device 5. Increase and decrease in voltage can be adjusted by the power source 3 and the resistor 30, and the voltage can be maintained at a required voltage. It should be noted that a power source having a built-in function of an electronic load may be used. The battery cell 100A has a positive electrode and a negative electrode, and the positive electrode is connected to the power source 3 and the resistor 30. Further, the negative electrode is connected to the power source 3 and the resistor 30. The battery cell 100A has a water supply port, a water supply pipe (not illustrated in the drawings) that is provided with a water supply pump 6 is connected to the supply port, and the water supply pump 6 is driven to supply water (H₂O). Furthermore, the battery cell 100A has a water discharge port, a water discharge pipe (not illustrated in the drawings) is connected to the discharge port, and excess water within the battery cell 100A is discharged from the discharge port. The battery cell 100A has an oxygen (O₂) gas discharge passage 101, and the discharge passage 101 is connected to the distillation device 5. Moreover, the battery cell 100A has a hydrogen (H₂) gas discharge passage 102, which is branched from the discharge passage 101. An electrolytic solution is accommodated within the distillation device 5, and the electrolytic solution within the distillation apparatus 5 and the electrolytic solution 40 within the housing 4 are circulated through a distribution pipe (not illustrated in the drawings), which is provided with a liquid feeding pump 7. The distillation device 5 has a water vapor (H₂O) discharge port 8. In FIG. 1, a gas flow meter (not illustrated in the drawings), a gas pack (not illustrated in the drawings), a backfire prevention valve (not illustrated in the drawings), and the like may be attached to the discharge passage 102, as necessary.

An example in which a resistor is used as the electronic load has been described above, but other than the resistor, for example, a variable resistor may be used.

The water electrolysis device 20A uses a nickel-hydrogen battery cell as the battery cell 100A. The nickel-hydrogen battery cell may be a spent nickel-hydrogen battery cell.

It should be noted that “spent” means that a charging capacity is lower than that of the battery immediately after production.

In the water electrolysis device 20A, a voltage is applied by the power source 3 and the resistor 30 so that the potential of the positive electrode in the battery cell 100A is higher than the potential of the negative electrode, for example. As a result, a water electrolysis reaction occurs in the water (H₂O) that has been supplied to the battery cell 100A, O₂ gas is generated from the positive electrode of the battery cell 100A, and H₂ gas is generated from the negative electrode. The water electrolysis reaction is shown below.

(Positive electrode) OH⁻→½H₂O+¼O₂+e⁻

(Negative electrode) H₂O+e⁻→½H₂+OH⁻

When O₂ gas is generated from the positive electrode of the battery cell 100A and H₂ gas is generated from the negative electrode, the gas can be extracted as oxyhydrogen (HHO) gas (mixed gas of hydrogen and oxygen). From the viewpoint of efficiently causing the water electrolysis reaction to occur in the water (H₂O) that has been supplied to the battery cell 100A, it is preferable to maintain the potential difference between the positive electrode and the negative electrode at 1.48 V or greater. From the viewpoint of easier progression of the water electrolysis reaction, it is more preferable that the potential difference obtained by subtracting the potential of the negative electrode from the potential of the positive electrode in the battery cell 100A is in a range of from 1.48 V to 2.00 V, and from the viewpoint of efficiency, a range of from 1.55 V to 1.80 V is even more preferable. When the generated oxyhydrogen (HHO) gas is extracted, the generated gas may be made to pass through the discharge passage 102 using a flow path switching valve or the like (not illustrated in the drawings).

Further, a voltage may be applied so that the potential difference between the potential of the positive electrode of the battery cell 100A and the potential of the negative electrode becomes a predetermined potential difference, to generate only hydrogen gas, or alternatively, to generate only oxygen gas. In this case, a post-process for separating the hydrogen gas and the oxygen gas becomes unnecessary.

Since the predetermined potential difference varies depending on the types (combination) of electrodes, the pH and temperature of the electrolytic solution, and other conditions, here, as an example, a case will be explained in which the positive electrode of the battery cell 100A is Ni(OH)₂, the negative electrode is LaNi₅, the pH of the electrolytic solution is 15, and the temperature is 30° C. It should be noted that, as the predetermined potential difference, a potential difference that generates only hydrogen may be referred to as a first potential difference, and a potential difference that generates only oxygen may be referred to as a second potential difference.

In a case of generating oxygen, the potential for generating oxygen is 1.48 V or greater, and is preferably 1.8 V.

In a case of generating hydrogen, the potential for generating hydrogen is-0.9 V or less, and is preferably −1.0 V.

Based on the aforementioned potential, a voltage is applied to both electrodes so as to generate only hydrogen. Alternatively, a voltage is applied to both electrodes by reversing the positivity and negativity of the voltage to be applied so as to generate only oxygen (so that a current flows in the direction opposite to the direction when hydrogen is generated).

In this manner, by repeatedly applying charging and discharging, hydrogen gas and oxygen gas can be generated at separate timings. The cycle of applying the voltage is not particularly limited as long as it is at least one time when charging and discharging is designated as 1 cycle. It may be 5 times, 10 times, 15 times, or 20 times, or may be 100 times. The electrochemical reaction during the charging and discharging in the nickel-metal hydride battery is shown below.

Charging→/←Discharging

(Positive electrode) Ni(OH)₂+OH⁻←→NiOOH+H₂O+e⁻

(Negative electrode) M+H₂O+e⁻←→MH+OH⁻

(Overall) Ni(OH)₂+M←→NiOOH+MH

Furthermore, the time for applying the voltage may be appropriately determined according to the positive electrode capacity of the battery. For example, this may be 72 seconds/Ah at 30 Acc for charging and discharging of from 20% to 80% of the positive electrode capacity of the battery, and may be 24 seconds/Ah at 30 Acc for charging and discharging of from 40% to 60% of the positive electrode capacity of the battery.

Below, the oxygen generation potentials (Table 1) and the hydrogen generation potentials (Table 2) at a pH of 15 and temperatures of from −30° C. to 80° C. of the electrolytic solution are shown. The first potential difference and the second potential difference at the respective temperatures may be appropriately determined with reference to the potentials shown in Table 1 and Table 2.

TABLE 1
E = E₀ + 2.303RT/ZF*log(0.2) − 2.303RT/ZF*4*(pH-14)
Gas constant R = 8.314 JK⁻¹ mol⁻
Faraday constant F = 96485 Cmol⁻
Number of moving electrons Z = 1
In(10) 2.302585093
Temperature

| ph | K | ° C. | E |
|---|---|---|---|
| 15 | 243 | −30 | 0.687 |
| 15 | 253 | −20 | 0.657 |
| 15 | 263 | −10 | 0.627 |
| 15 | 273 | 0 | 0.598 |
| 15 | 283 | 10 | 0.568 |
| 15 | 293 | 20 | 0.538 |
| 15 | 303 | 30 | 0.508 |
| 15 | 313 | 40 | 0.478 |
| 15 | 323 | 50 | 0.449 |
| 15 | 333 | 60 | 0.419 |
| 15 | 343 | 70 | 0.389 |
| 15 | 353 | 80 | 0.359 |

TABLE 2
E = E₀ + 2.303RT/ZF*(−2 pH)
Gas constant R = 8.314 JK⁻¹ mol⁻
Faraday constant F = 96485 Cmol⁻
Number of moving electrons Z = 1
In(10) 2.302585093
Temperature

| ph | K | ° C. | E |
|---|---|---|---|
| 15 | 243 | −30 | −0.751 |
| 15 | 253 | −20 | −0.775 |
| 15 | 263 | −10 | −0.800 |
| 15 | 273 | 0 | −0.824 |
| 15 | 283 | 10 | −0.848 |
| 15 | 293 | 20 | −0.872 |
| 15 | 303 | 30 | −0.896 |
| 15 | 313 | 40 | −0.920 |
| 15 | 323 | 50 | −0.944 |
| 15 | 333 | 60 | −0.969 |
| 15 | 343 | 70 | −0.993 |
| 15 | 353 | 80 | −1.017 |

In a case in which only the H₂ gas is to be extracted, the discharge passage 102 shown in FIG. 1 may be opened when the H₂ gas is generated, and the discharge passage 101 may be closed. When the O₂ gas is generated, the O₂ gas may be sent to the distillation device 5 through the discharge passage 101, and may be reduced at the distillation device 5 to be extracted from the discharge port 8 as water vapor (H₂O).

According to the present disclosure, by applying a voltage so that the potential difference between the positive electrode and the negative electrode becomes the predetermined potential difference, oxygen gas and hydrogen gas can be generated in such a manner that the positive electrode and the negative electrode do not deteriorate, leading to improvement in durability of the water electrolysis device.

Next, another exemplary embodiment will be explained.

### Battery Module

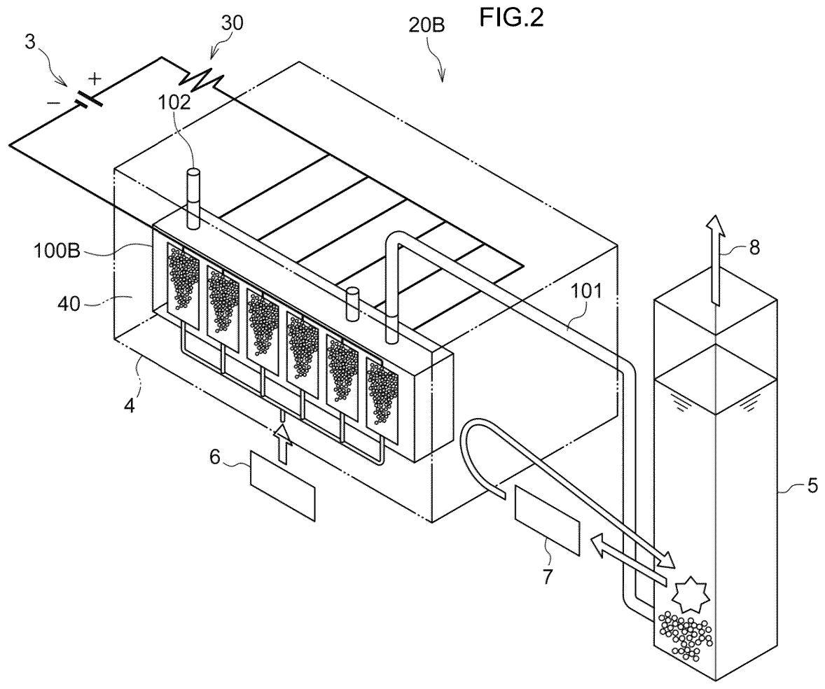

Another exemplary embodiment of the water electrolysis method according to the present disclosure will be explained with reference to the device illustrated in FIG. 2, in which a “battery module” is used as a single nickel-hydrogen battery. It should be noted that configurations that are the same as those of the device shown in FIG. 1 are denoted by the same reference numerals, and redundant explanation thereof will be omitted.

FIG. 2 is a schematic perspective view illustrating a water electrolysis device for implementing the water electrolysis method of the present disclosure. As shown in FIG. 2, a water electrolysis device 20B includes the power source 3, the resistor 30, the housing 4 in which the electrolytic solution 40 is accommodated, a battery module 100B that is immersed in the electrolytic solution 40 within the housing 4, and the distillation device 5. In the water electrolysis device 20B, plural nickel-hydrogen battery cells (in FIG. 2, a nickel-hydrogen battery module having six pairs) are used as the battery module 100B. Each of the six nickel-hydrogen battery cells in the battery module 100B has a positive electrode and a negative electrode, and each positive electrode is connected to the power source 3 and the resistor 30. Further, each negative electrode is connected to the power source 3 and the resistor 30. The battery module 100B has a water supply port, a water supply pipe (not illustrated in the drawings) that is provided with the water supply pump 6 is connected to the supply port, and water (H₂O) is supplied by driving of the water supply pump 6. The battery module 100B has the oxygen (O₂) gas discharge passage 101, and the discharge passage 101 is connected to the distillation device 5. Furthermore, the battery module 100B has the hydrogen (H₂) gas discharge passage 102, which is separate from the discharge passage 101.

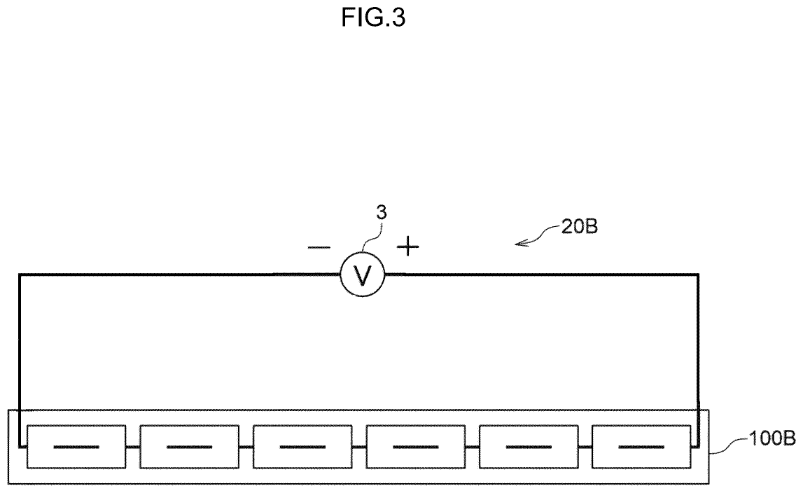

In this regard, FIG. 3 shows an example of a configuration of connection between the plural (six pairs in FIG. 2) nickel-hydrogen battery cells included in the battery module 100B, and the power source 3, in the water electrolysis device 20B shown in FIG. 2. It should be noted that, in FIG. 3, configurations other than the battery module 100B and the power source 3 are omitted, and that description of the electronic load is also omitted. As shown in FIG. 3, each of the positive electrodes and the negative electrodes respectively included in the plural nickel-hydrogen battery cells included in the battery module 100B are connected (short-circuit connected) to the power source 3. For example, the power source 3 may be respectively connected to a positive electrode terminal and a negative electrode terminal of the battery module 100B.

In the water electrolysis device 20B, the nickel-hydrogen battery module used for the battery module 100B may be a spent nickel-hydrogen battery module. Furthermore, in the water electrolysis device 20B, the voltage to be applied may be the voltage of the water electrolysis device 20A×the number of cells.

### Preferred Aspects

### Electrolytic Solution

From the viewpoint of efficiently causing the water electrolysis reaction to occur, the electrolytic solution in which the nickel-hydrogen battery is immersed preferably has a pH of 14 or greater, more preferably has a pH of 15 or greater, and even more preferably has a pH of 16 or greater. The pH is a value measured at 25° C. using a pH meter.

The electrolytic solution is not particularly limited, but is preferably an aqueous electrolytic solution. As the aqueous electrolytic solution, for example, an aqueous alkali solution can be suitably used. The aqueous alkali solution contains, for example, water and an alkali metal hydroxide dissolved in the water. The alkali metal hydroxide may have, for example, a concentration of from 1 mol/L to 45 mol/L. Examples of the alkali metal hydroxide include potassium hydroxide (KOH), sodium hydroxide (NaOH), lithium hydroxide (LiOH) and the like.

### Temperature

From the viewpoint of ease of occurrence of the water electrolysis reaction, a temperature of the entire water electrolysis device is preferably high with 80° C. being designated as an upper limit, and, for example, is preferably from 20° C. to 80° C., more preferably from 40° C. to 80° C., and even more preferably from 50° C. to 80° C. Measurement of the temperature of the entire water electrolysis device is carried out by measuring a temperature of the electrolytic solution.

Ni₂O₃H Coating Film

In the background art of the present application, it is disclosed that, although the reaction reversibly continues if the valence variation of Ni is between divalent and trivalent, when the potential variation is increased to provide a valence variation of between divalent and tetravalent, an oxide coating film (an Ni₂O₃H coating film) is formed on the positive electrode, and the efficiency of gas generation is adversely affected. However, in the present disclosure, a valence variation of between divalent and tetravalent may be intentionally provided in the Ni of the negative electrode, and an Ni₂O₃H coating film may be formed at a surface of the negative electrode.

The negative electrode of the nickel-hydrogen battery has a hydrogen storage alloy including a mischmetal. The hydrogen storage alloy has the characteristic of occluding hydrogen or reversibly releasing hydrogen. Thus, in order to prevent the occlusion of hydrogen that has been generated at the negative electrode side, by the hydrogen storage alloy, in the electrolytic solution, an Ni₂O₃H coating film may be formed at the surface of the negative electrode. The Ni₂O₃H coating film is a film that contains Ni₂O₃H as a main component (a component having a largest mass) and that has corrosion resistance and conductivity. A thickness of the coating film is not particularly limited, but is, for example, from 100 to 200 nm. For a details of the Ni₂O₃H coating film, reference can be made to Japanese Patent Application Laid-Open (JP-A) No. 2022-45695.

### Method for Forming Coating Film

In a method for forming the coating film, a material for forming the coating film (for example, LaNi₅) is exposed to air.

Next, in a state in which the material for forming the coating film (for example, LaNi₅) is immersed in an acidic solution (pH of 7 or less), a first potential (upper potential) and a second potential (lower potential) are alternately and repeatedly applied to the LaNi₅, whereby the Ni₂O₃H coating film is formed on a surface of the LaNi₅.

The first potential is within a potential range in which Ni is tetravalent in an Ni—H₂O system.

The second potential is within a potential range in which Ni is divalent in the Ni—H₂O system.

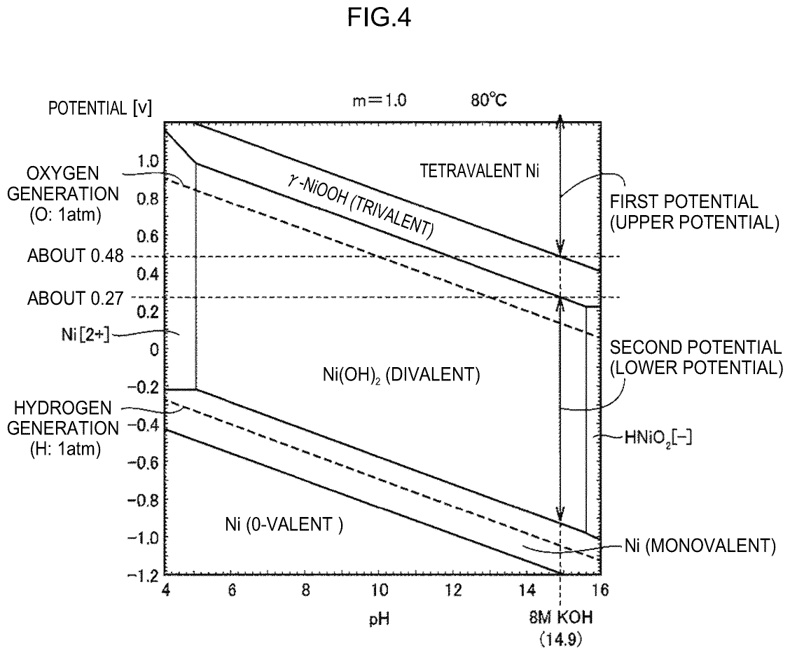

The first potential (upper potential) and the second potential (lower potential) vary depending on a temperature and a pH of the solution. FIG. 4 is a potential-pH diagram for Ni (Ni—H₂O system) at 80° C. (a diagram showing regions of existence of respective chemical species of Ni in water, on two-dimensional coordinates of electrode potential and pH).

With reference to FIG. 4, the case of an alkaline solution will be explained. It should be noted that the same applies to the case of an acidic solution. For example, in a case in which an 8M KOH aqueous solution (pH of 14.9) is used at 80° C., the first potential (the potential at which Ni becomes tetravalent) is a potential that is higher than about 0.48 V (SHE reference potential). The second potential (the potential at which Ni becomes divalent) is a potential within a range of about 0.27 V (SHE reference potential) or less.

The first potential is preferably about 0.48 V or greater, and because the formation speed becomes slow if it is too low, and because the formation efficiency becomes poor if it is too high in combination with the second potential, the first potential is preferably appropriately set within this range.

The second potential is preferably about 0.27 V or less, and because the formation speed becomes slow if it is too high, and because the ratio of the Ni₂O₃H with respect to the LaNi₅ becomes small if it is too low, the second potential is preferably appropriately set within this range.

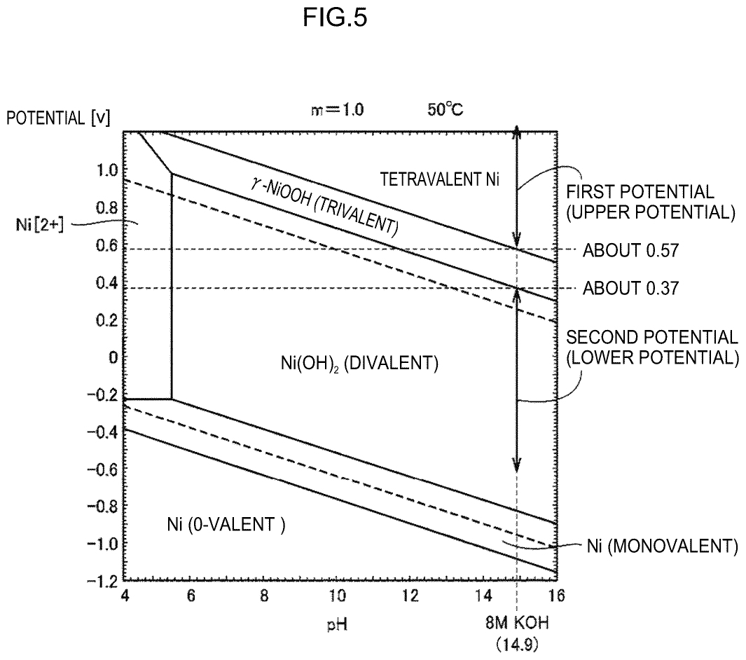

FIG. 5 is a potential-pH diagram for Ni at 50° C. As shown in FIG. 5, for example, in a case in which an 8M KOH aqueous solution is used at 50° C., the first potential is a potential that is higher than about 0.57 V. The second potential is a potential that is about 0.37 V or less.

As shown in FIGS. 4 and 5, the ranges of the first potential and the second potential used in the method for forming the coating film vary depending on changes in the pH, the temperature, and the like of the solution. Therefore, it is desirable to apply the potentials in appropriate ranges of the first potential and the second potential that satisfy the above conditions in accordance with the pH, the temperature, and the like of the solution. The temperature of the solution is preferably from 40 to 90° C., and more preferably from 45 to 85° C. In the case of an alkaline solution, the pH is preferably 10 or greater, more preferably 12 or greater, and even more preferably 14 or greater.

Specific examples of the alkaline solution include a KOH solution, an NaOH solution, a LiOH solution, and the like, and the alkaline solution is preferably a KOH solution or an NaOH solution. The concentration of the alkaline solution is preferably a concentration that results in the pH described above.

The respective application times, for one time, for the first voltage and the second voltage are, for example, 5 seconds for the first voltage and 10 seconds for the second voltage, and are appropriately set for each combination of solution conditions (solution type, pH, and temperature). The total application time for the first voltage and the second voltage is appropriately set so as to obtain a desired thickness of the Ni₂O₃H coating film.

### Nickel-Hydrogen Battery

Next, a nickel-hydrogen battery that can be used in the water electrolysis method of the present disclosure will be explained.

It should be noted that the nickel-hydrogen battery (hereinafter, sometimes abbreviated as the “battery”) may be, for example, a spent nickel-hydrogen battery that has been used for a battery for a portable device, a vehicle-mounted battery, a battery for renewable energy generation, or the like.

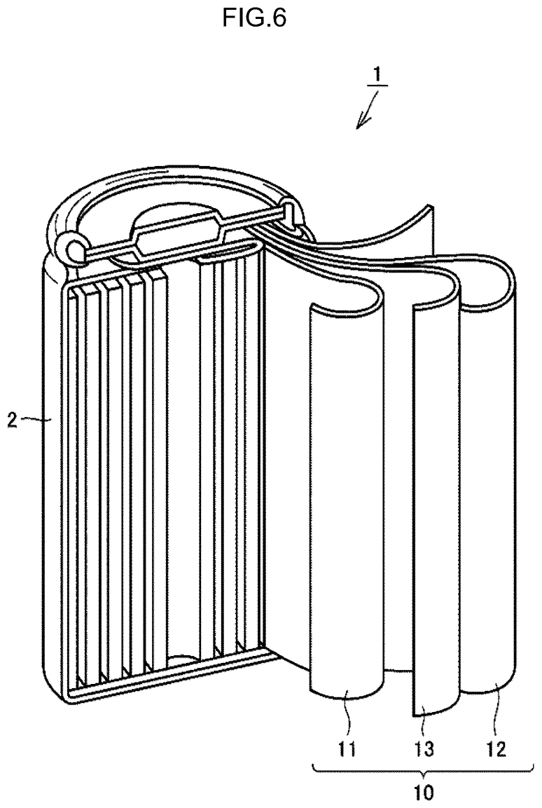

FIG. 6 is a schematic configuration diagram showing an example of a configuration of a nickel-hydrogen battery cell.

A battery cell 1 is a nickel-hydrogen battery cell. The battery cell 1 includes a housing 2. The housing 2 is a cylindrical case. The housing 2 is made of metal. However, the housing 2 can have an arbitrary form. The housing 2 may be, for example, a rectangular case. The housing 2 may be, for example, a pouch made of an aluminum laminate film, or the like. The housing 2 may, for example, be made of resin.

The housing 2 houses a power storage element 10 and an electrolytic solution. The power storage element 10 includes a positive electrode 11, a negative electrode 12, and a separator 13. The illustrated power storage element 10 is of a wound type. The power storage element 10 is formed by winding a band-shaped electrode in a spiral shape. The power storage element 10 may be, for example, of a laminated type. The power storage element 10 may be formed, for example, by laminating wafer-shaped electrodes.

### Negative Electrode

The negative electrode 12 has a sheet shape. The negative electrode 12 may have a thickness of, for example, from 10 μm to 1 mm. The negative electrode 12 has a lower potential than the positive electrode 11.

The negative electrode includes, for example, a negative electrode current collector and a negative electrode active material. Examples of the negative electrode current collector include, for example, nickel mesh and the like. Examples of the negative electrode active material include, for example, a hydrogen storage alloy. A composition of the hydrogen storage alloy is not limited so long as it can occlude and release hydrogen. Examples of the hydrogen storage alloy include, for example, an Mm-Ni—Mn—Al—Co alloy. “Mm” denotes a mixture of rare earth elements called a mischmetal. Specific examples thereof include La—Ni alloys such as LaNi₅ and the like.

### Positive Electrode

The positive electrode 11 has a sheet shape. The positive electrode 11 may have a thickness of, for example, from 10 μm to 1 mm. The positive electrode 11 has a higher potential than the negative electrode 12. The positive electrode 11 contains a positive electrode active material. The positive electrode active material can include an arbitrary component. Examples of the positive electrode active material include, for example, nickel hydroxide (Ni(OH)₂), cobalt hydroxide (Co(OH)₂), manganese dioxide, silver oxide, and the like. The positive electrode active material is preferably nickel hydroxide.

The positive electrode 11 may be substantially composed of only the positive electrode active material. The positive electrode 11 may further contain, in addition to the positive electrode active material, a current collector, a conductive material, a binder and the like. The current collector may contain, for example, a porous metal sheet or the like. The current collector is, for example, made of of Ni.

For example, the positive electrode 11 can be formed by applying the positive electrode active material, the conductive material, and the binder to the current collector. The conductive material has electronic conductivity. The conductive material can include an arbitrary component. The conductive material may contain, for example, carbon black, Co, cobalt oxide, or the like. A blending amount of the conductive material may be, for example, from 0.1 parts by mass to 10 parts by mass, with respect to 100 parts by mass of the positive electrode active material. The binder binds the current collector and the positive electrode active material. The binder can include an arbitrary component. The binder may contain, for example, ethylene vinyl acetate (EVA) or the like. A blending amount of the binder may be, for example, from 0.1 parts by mass to 10 parts by mass, with respect to 100 parts by mass of the positive electrode active material.

### Separator

The separator 13 has a sheet shape. The separator 13 is arranged between the positive electrode 11 and the negative electrode 12. The separator 13 physically separates the positive electrode 11 and the negative electrode 12. The separator 13 may have a thickness of, for example, from 50 μm to 500 μm. The separator 13 is porous. The separator 13 may contain, for example, a stretched porous film, a nonwoven fabric, or the like. The separator 13 is electrically insulating. The separator may be, for example, made of polyolefin, polyamide, or the like.

### Electrolytic Solution

The electrolytic solution is not particularly limited, but is preferably an aqueous electrolytic solution. As the aqueous electrolytic solution, for example, an aqueous alkali solution can be suitably used. The aqueous alkali solution contains, for example, water and an alkali metal hydroxide dissolved in the water. The alkali metal hydroxide may have, for example, a concentration of from 1 mol/L to 20 mol/L. Examples of the alkali metal hydroxide include, for example, potassium hydroxide (KOH), sodium hydroxide (NaOH), lithium hydroxide (LiOH), and the like.

As described above, according to the water electrolysis method of the present disclosure, by reusing a spent nickel-hydrogen battery, H₂ gas and O₂ gas having high purity can be safely extracted with high efficiency. Further, since the time when the O₂ gas is generated and the time when the H₂ gas is generated can be temporally separated, H₂ gas and O₂ gas having high purity can be separately and safely extracted.

Furthermore, according to the present disclosure, in a case in which the negative electrode contains an oxygen-occluding substance such as lanthanum or the like, only the negative electrode can be made to oxidize with a potential difference at which the positive electrode does not deteriorate (lanthanum of the negative electrode can be deactivated). In other words, an Ni₂O₃H coating film can be formed only at the negative electrode. Hydrogen can then be generated from the lanthanum-containing electrode in subsequent water electrolysis.

### EXAMPLES

Generation of hydrogen gas and oxygen gas in the water electrolysis method according to the exemplary embodiments of the present disclosure was confirmed by experiment.

### Example 1

An experiment was conducted using a water electrolysis device having the same configuration as that of the water electrolysis device 20B shown in FIG. 2. The following were used as the electrolytic solution and the battery module.

Electrolytic solution: potassium hydroxide (KOHaq, pH of 15)

Battery module: spent battery module NP2, manufactured by Primearth EV Energy Co., Ltd.

As in the water electrolysis device 20B shown in FIG. 2, the water electrolysis device has one power source, and the battery module (NP2) has 6 battery cells. The NP2 was used in a state in which an upper lid plate was removed and each battery cell was opened. A positive electrode terminal and a negative electrode terminal of the NP2 were both connected to the power source. It should be noted that, in addition to the power source, the positive electrode terminal and the negative electrode terminal were also connected to a resistor serving as an electronic load.

In this water electrolysis device, at room temperature (20° C.), water (H₂O) was supplied from a water supply pump to the NP2, and a voltage was maintained by the power source and the resistor so that a potential of positive electrode in the NP2 was higher than a potential of negative electrode.

It was confirmed that oxygen (O₂) gas and hydrogen (H₂) gas were discharged after maintaining of the voltage was started.

Upon performing water electrolysis using the spent NP2, extremely high energy conversion efficiency (68.0%) was exhibited as shown in Table 3, despite measurement at room temperature (20° C.).

TABLE 3
Electricity-Oxyhydrogen Gas Energy Conversion Efficiency

| | Input electrical | | HHO gas generation | | Conversion | |
|---|---|---|---|---|---|---|
| | energy | | amount | | efficiency | |
| | /kWh | /MJ | X/L/h | Y/MJ | E (LHV) % | Notes |
| Example 1 | 0.494 | 1.78 | 169 | 1.21 | 68.0 | Alkali |
| | | | (H₂ 10.1 g) | | | |

Y = X × 2/3/22.4 × 242/1000

As described above, hydrogen (H₂) gas can be recovered with high efficiency by a water electrolysis reaction using a battery module, and particularly using a spent battery module. In this manner, the water electrolysis method according to the present disclosure can exhibit excellent effects and can contribute to the transition to a circular economy (circulation-based economy) society.

Further, in the water electrolysis method according to the present disclosure, by applying a voltage so as to provide a predetermined potential difference, hydrogen (H₂) gas and oxygen (O₂) gas can be separately recovered from a single battery module, and therefore, a post-process for separating the hydrogen gas becomes unnecessary. Furthermore, when the predetermined potential difference is used, hydrogen (H₂) gas and oxygen (O₂) gas can be generated with a potential difference at which the positive and negative electrodes do not deteriorate, and durability of the water electrolysis cell can be improved.

What is claimed is:

1. A water electrolysis method comprising:
by using:
a power source,
an electrolytic solution that is capable of transferring OH-ions, and
a single nickel-hydrogen battery that has a positive electrode connected to the power source, and a negative electrode connected to the power source, and that is immersed in the electrolytic solution,
applying, by the power source, a potential difference in which a potential of the positive electrode is higher than a potential of the negative electrode, to generate oxygen gas from the positive electrode and hydrogen gas from the negative electrode.

2. The water electrolysis method according to claim 1, wherein the negative electrode comprises a mischmetal.

3. The water electrolysis method according to claim 1, wherein:
the negative electrode has a coating film containing Ni₂O₃H; and
a voltage is applied so that the positive electrode and the negative electrode have a predetermined first potential difference to generate only hydrogen gas, or a voltage is applied so that the positive electrode and the negative electrode have a predetermined second potential difference to generate only oxygen gas.
